(19) United States
(12) Patent Application Publication
(10) Pub. No.: US 2023/0214851 A1
(43) Pub. Date: Jul. 6, 2023

(54) INSPECTION PROGRAM AND INSPECTION SYSTEM

(71) Applicant: Square Enix Co., Ltd., Tokyo (JP)

(72) Inventors: Makoto TSUDA, Tokyo (JP); Hirokazu WATANABE, Tokyo (JP); Keita SHIBATA, Tokyo (JP)

(21) Appl. No.: 18/150,628

(22) Filed: Jan. 5, 2023

(30) Foreign Application Priority Data
Jan. 5, 2022 (JP) 2022-000761

(51) Int. Cl. G06Q 30/018; G06Q 30/0207; A63F 13/73; A63F 13/79

(52) U.S. Cl. CPC G06Q 30/0185; G06Q 30/0209; A63F 13/73; A63F 13/79

(57) ABSTRACT

An inspection program causes a server to implement an image acquisition function to acquire an image, a determination function to determine whether or not the initial object is a genuine object based on at least a portion of a first object included in the image or at least a portion of a second object pertaining to the first object, and a certificate issuance function to issue an NFT certificate corresponding to the first object if the first object is determined to be a genuine object.

### CROSS-REFERENCE TO RELATED APPLICATION

This application claims priority to and the benefit of Japanese Patent Application No. 2022-000761 filed on Jan. 5, 2022, the disclosure of which is expressly incorporated herein by reference in its entirety.

### BACKGROUND

At least one embodiment of the present disclosure relates to an inspection program and an inspection system.

Figures and other products related to games are available for purchase.

Examples of an object recognition device consisting of an image interface and a processor may be found in Japanese Patent Application Publication 2021-018470 A. The image interface receives image data from a captured image. The processor identifies the classification of the object in the image using a classification dictionary file generated by machine learning. The processor selects an object-specific dictionary corresponding to the object's classification from a plurality of object-specific dictionaries, each corresponding to a plurality of classifications. The processor identifies the object from the captured image based on the selected object-specific dictionary.

It is a commercial practice to sell goods such as figures with a certificate of authenticity included certifying that the goods are indeed genuine. However, recently other sales channels other than direct sales from the seller have emerged, such as third-party sales via the Internet. This led to a potential need of being able to issue a certificate indicating that a product, i.e., an object, is genuine after it has been received by the user.

### SUMMARY

The purpose of at least one embodiment of the present disclosure is to solve the above problem and to enable a certificate to be issued after the fact to the person who received the object, indicating that the object is genuine.

From a non-limiting aspect, in accordance with one embodiment of the present disclosure, a non-transitory computer-readable medium comprises an inspection program including a server with an image acquisition function to acquire an image, a determination function to determine whether or not a first object is a genuine object based on at least a portion of the first object or at least a portion of a second object pertaining to the first object included in the image and a certificate issuing function to issue a Non-Fungible Token (NFT) certificate corresponding to the first object when the first object is determined to be genuine.

From a non-limiting aspect, in accordance with one embodiment of the present disclosure, an inspection system comprises a communication network, a server, and a user terminal. The system includes an image acquisition function for acquiring an image, a determination function for determining whether or not the first object is a genuine object based on at least a portion of the first object or at least a portion of a second object pertaining to the first object included in the image, and a certificate issuing function to issue an NFT certificate corresponding to the first object when the first object is determined to be genuine.

From a non-limiting aspect, in accordance with one embodiment of the present disclosure, a non-transitory computer-readable medium comprises an inspection program including an image acquisition function that causes a computer system to acquire an image, a determination function that determines whether or not a first object is a genuine object based on at least a portion of the first object or at least a portion of a second object pertaining to the first object included in the image, and a certificate issuing function that issues an NFT certificate corresponding to the first object when the first object is determined to be genuine.

Each embodiment of the present disclosure resolves one or more deficiencies.

### BRIEF DESCRIPTION OF DRAWINGS

FIG. 1 is a block diagram illustrating an example of the configuration of an inspection system according to at least one of the embodiments of the present disclosure.

FIG. 2 is a block diagram illustrating the configuration of a server according to at least one of the embodiments of the present disclosure.

FIG. 3 is a flowchart illustrating an example of the processing of an inspection program according to at least one of the embodiments of the present disclosure.

FIG. 4 is a block diagram illustrating the configuration of a server according to at least one of the embodiments of the present disclosure.

FIG. 5 is a flowchart illustrating an example of the processing of an inspection program according to at least one of the embodiments of the present disclosure.

FIG. 6 is a block diagram illustrating the configuration of a server according to at least one of the embodiments of the present disclosure.

FIG. 7 is a flowchart illustrating an example of the processing of an inspection program according to at least one of the embodiments of the present disclosure.

FIG. 8 is a block diagram illustrating an example of the configuration of an inspection system according to at least one of the embodiments of the present disclosure.

FIG. 9 is a block diagram illustrating the configuration of an inspection system according to at least one of the embodiments of the present disclosure.

FIG. 10 is a flowchart illustrating an example of processing of an inspection program executed by an inspection system according to at least one of the embodiments of the present disclosure.

FIG. 11 is a block diagram illustrating the configuration of a user terminal according to at least one of the embodiments of the present disclosure.

FIG. 12 is a flowchart illustrating an example of the processing of an inspection program according to at least one of the embodiments of the present disclosure.

FIG. 13 is a block diagram illustrating the configuration of a server according to at least one of the embodiments of the present disclosure.

FIG. 14 is a flowchart illustrating an example of the processing of an inspection program according to at least one of the embodiments of the present disclosure.

FIG. 15 is a second flowchart illustrating an example of the processing of an inspection program according to at least one of the embodiments of the present disclosure.

FIG. 16 is a conceptual diagram illustrating the inspection process of the first object according to at least one of the embodiments of the present disclosure.

### DESCRIPTION OF EMBODIMENTS

Example embodiments of the present disclosure are described below with reference to accompanying drawings. The various components in each of the example embodiments described below can be combined as appropriate to the extent that no contradictions or other problems arise. Further, the contents described in one embodiment may be omitted in other embodiments. Operations and processes that are not related to the characteristic parts of each embodiment may be omitted. Furthermore, the order of the various processes that comprise the various flows and sequences described below are not in any particular order to the extent that there is no inconsistency in the processing content.

### First Embodiment

The following is an overview of a first embodiment of the present disclosure.

The following is an example of a first embodiment with a computer example of an inspection program executed on a server.

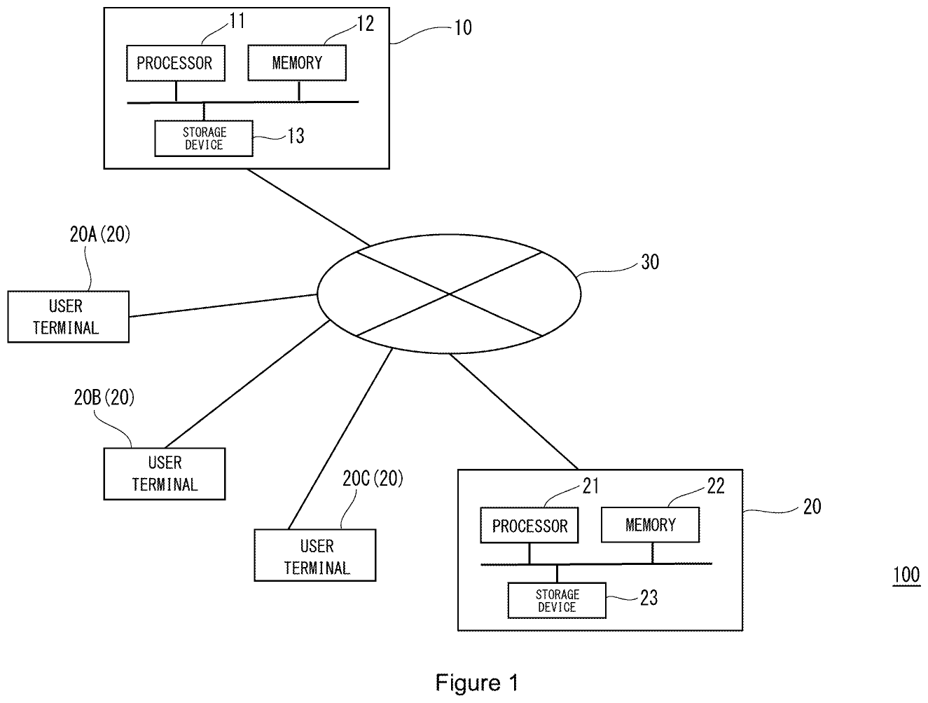

FIG. 1 is a block diagram illustrating an example configuration of an inspection system 100 according to at least one embodiment of the present disclosure. The inspection system 100, which is an example of an inspection system, has a server 10 and a user terminal 20 operated by a user. User terminals 20A, 20B, and 20C are examples of user terminals 20, respectively. The configuration of the inspection system 100 is not limited to this. For example, the inspection system 100 may be configured so that a single-user terminal is used by multiple users. The inspection system 100 may have multiple servers.

Server 10 and user terminal 20 are computer examples. Server 10 and user terminal 20 are each communicatively connected to a communication network 30, such as the Internet. The connection between the communication network 30 and the server 10 and between the communication network 30 and the user terminal 20 may be a wired or wireless connection. For example, the user terminal 20 may connect to the communication network 30 by performing data communication with a base station managed by a telecommunications carrier via a wireless communication line.

The inspection system 100 is equipped with a server 10 and a user terminal 20 to realize various functions for executing various processes in response to user operations.

The inspection system 100 may also serve as a game processing system. The games processed by the game processing system may be video games, games that utilize real space, with or without XR technology, etc. In the case where the inspection system 100 also serves as a game processing system, the server 10 controls the game's progression. The server 10 may control the game's progression in response to player operations. The server 10 is managed by the administrator of the inspection system 100 and has various functions for providing information on various processes to a plurality of user terminals 20. The server 10 may consist of an information processing device, such as a game server, capable of rendering game images. The inspection system and game processing system may be configured by multiple servers.

Server 10 has a processor 11, memory 12, and storage device 13. The processor 11 is a central processing unit such as a central processing unit (CPU) that performs various calculations and controls. If server 10 is equipped with a GPU (Graphics Processing Unit), some of the various calculations and controls may be performed by the GPU. The server 10 executes various types of information processing by the processor 11 using data read out to the memory 12, and stores the resulting processing results in the storage device 13, as necessary.

The storage device 13 functions as a storage medium for storing various types of information. The configuration of the storage device 13 is not particularly limited, but from the viewpoint of reducing the processing load on the user terminal 20, it is preferable to have a configuration that can store all the various information necessary for the control performed by the inspection system 100. Such examples include HDDs and SSDs. However, the storage device that stores various types of information may be configured to have a dedicated storage area outside of the server 10, for example, as long as the storage area is accessible by the server 10.

The user terminal 20 is connected to the communication network 30 and is equipped with hardware (e.g., a display device that displays a browser screen or game screen according to coordinates) and software to execute various processes by communicating with the server 10. Each of the multiple user terminals 20 may also be configured to communicate directly with each other without the server 10.

The user terminal 20 may include a communication terminal that is managed by the user and capable of playing network-distributed games. Examples of communication terminals include, for example, cell phone terminals, PDAs (Personal Digital Assistant), portable gaming devices, VR goggles, AR glasses, smart glasses, AR contacts, and so-called wearable devices. The configuration of user terminals that the inspection system 100 may include is not limited to these. Other examples of user terminal configurations include a combination of various communication terminals, personal computers, and stationary gaming devices.

The user terminal 20 may have a built-in display device. The display device may be connected wirelessly or wired to the user terminal 20. Since the configuration of the display unit is very common, it is not shown here.

When a user terminal is used for gaming purposes, the game screen is displayed by a display device, for example, as a composite image, and the user recognizes this composite image. The game screen is displayed, for example, on a display device provided by the user terminal or a display device connected to the user terminal. Display devices include, for example, hologram display devices that can display holograms, projection devices that project images (including game screens) onto screens, etc., and XR display devices. XR includes Virtual Reality (VR), Augmented Reality (AR), Mixed Reality (MR), and Substitutional Reality (SR).

User terminal 20 has a processor 21, memory 22, and storage device 23. The processor 21 is a central processing unit such as a central processing unit (CPU) that performs various calculations and controls. If the user terminal 20 is equipped with a GPU (Graphics Processing Unit), some of the various calculations and controls may be performed by the GPU. The user terminal 20 executes various types of information processing by the processor 21 using the data read out to the memory 22, and stores the resulting processing results in the memory device 23, as necessary. The storage device 23 functions as a storage medium for storing various types of information.

The user terminal 20 may have a built-in input device. The input device may be connected wirelessly or wired to the user terminal 20. The input device accepts operational input by the user. In response to operation input by the user, the processor provided by the server 10 or the user terminal 20 executes various control processes. Examples of input devices include the touch panel screen provided by mobile terminals, keyboards, mice, gamepads, joysticks, and other controllers. A camera built into or connected to the user terminal 20 can also correspond to an input device. The user performs operation input by gestures such as moving his/her hand in front of the camera (gesture input).

In addition, the user terminal 20 may be equipped with other output devices such as speakers. Other output devices output sound, vibration, and various other information to the user.

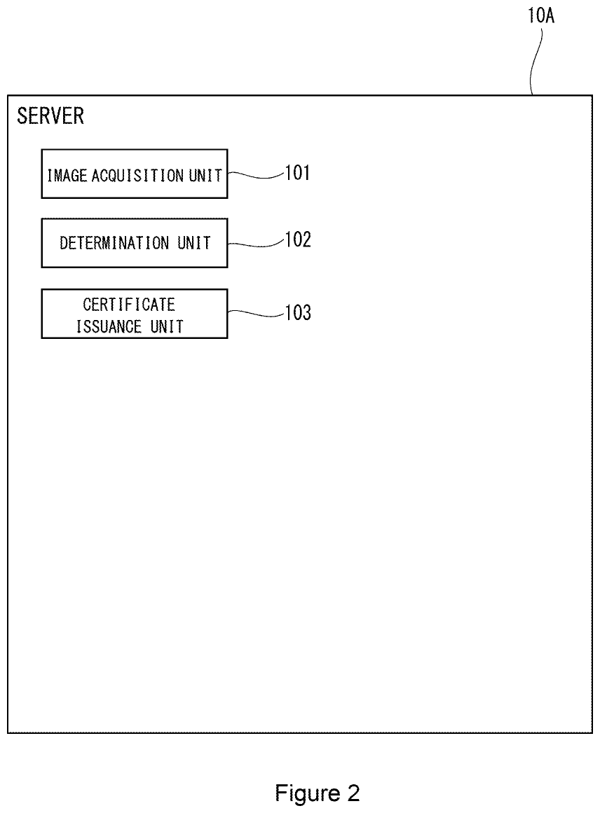

FIG. 2 is a block diagram illustrating the configuration of a server according to at least one of the embodiments of the present disclosure The server 10A, an example of the configuration of server 10, has at least an image acquisition unit 101, a determination unit 102 and a certificate issuance unit 103. The processor provided with the server 10A refers to the inspection program held in the memory device and executes the program to functionally realize the image acquisition unit 101, the determination unit 102 and the certificate issuance unit 103.

The image acquisition unit 101 has the function of acquiring images. The determination unit 102 has the function of determining whether or not a first object is a genuine object based on at least a portion of the first object or at least a portion of the second object pertaining to the first object included in the image. The certificate issuing unit 103 has the function of issuing an NFT certificate corresponding to the first object when the first object is determined to be genuine.

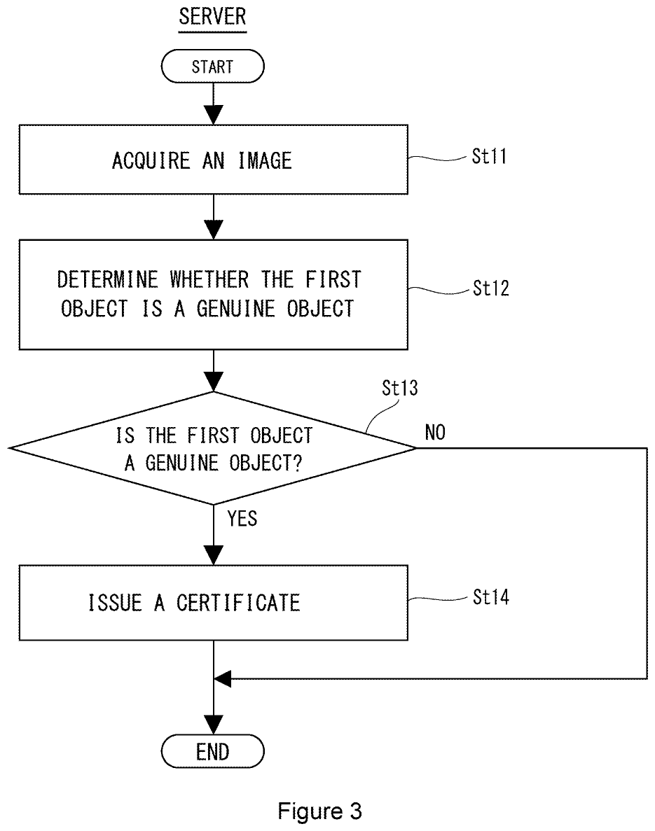

Following is an outline of the program execution process in the first embodiment of the present disclosure. FIG. 3 is flowchart illustrating an example of processing an inspection program according to at least one embodiment of the present disclosure.

The image acquisition unit 101 acquires an image (St 11). The determination unit 102 determines whether the first object is a genuine object based on at least a portion of the first object or at least a portion of the second object pertaining to the first object in the image (St 12). If the certificate issuing unit 103 determines that the first object is a genuine object (St 13: YES), the unit 103 issues an NFT certificate corresponding to the first object (St 14).

The image may be, for example, an image captured by an imaging device provided by the user terminal. The image may be a still or moving image. The server 10A may acquire the captured images directly from the imaging device or via communication network 30.

The image may be an image captured or generated by a device other than the user terminal. For example, it may be an image captured by an imaging device installed in a store that the user can visit. The stores that the user can visit may be real-world stores or virtual stores located in virtual space. The image may be an image captured or generated in a virtual space.

The first object in the image is the object for which we want to determine whether it is a genuine object or not (authenticity). For example, the first object could be a sold product or other goods.

A second object pertaining to the first object is any other object related to the first object. Related means, for example, that one is attached to the other or that one is packed by the other. To give an example, the second object is a box that packages the figure or a card that comes with the figure. However, the second object is not limited to boxes or cards.

A part of an object may mean, for example, a face, limbs, or other parts if the object is a figure. For example, a part may be only the eye portion of the figure's face. A part can be any part that can be determined to be authentic or fake, and is not limited to the face, limbs, eyes, etc. mentioned above.

The object may be an inanimate object. For example, the object may be a 3D object corresponding to a tangible object such as a figure.

An authentic product means one that is not a fake. For example, goods that have been legitimately sold fall under the category of genuine goods.

An NFT certificate corresponding to the first object means data containing information pertaining to the token associated with the first object. The tokens are NFTs that are registered on the blockchain.

As an aspect of the first embodiment, a certificate can be issued after the fact to the person who received the object, indicating that the object is genuine.

### Second Embodiment

The following is an overview of a second embodiment of the present disclosure.

The following is an example of a second embodiment with a computer example of an inspection program executed on a server. The server may be the server 10 provided by the inspection system 100 described in FIG. 1.

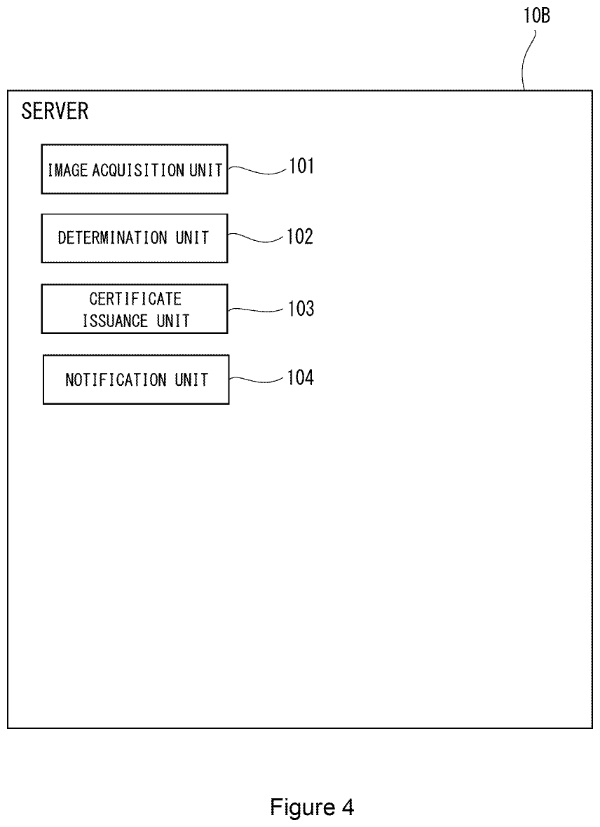

FIG. 4 is a block diagram illustrating the configuration of a server according to at least one embodiment of the present disclosure. The server 10B, an example of the configuration of server 10, is equipped with at least an image acquisition unit 101, a determination unit 102, a certificate issuing unit 103 and a notification unit 104. The processor provided by the server 10B functionally realizes image acquisition unit 101, determination unit 102, certificate issuance unit 103 and notification unit 104 by referring to an inspection program retained in a memory device and executing the program.

The image acquisition unit 101 has the function of acquiring images. The determination unit 102 has the function of determining whether or not a first object is a genuine object based on at least a portion of the first object or at least a portion of the second object pertaining to the first object included in the image. The certificate issuing unit 103 has the function of issuing an NFT certificate corresponding to the first object when the first object is determined to be genuine. The notification unit 104 has the function of notifying when the first object is determined as not being genuine.

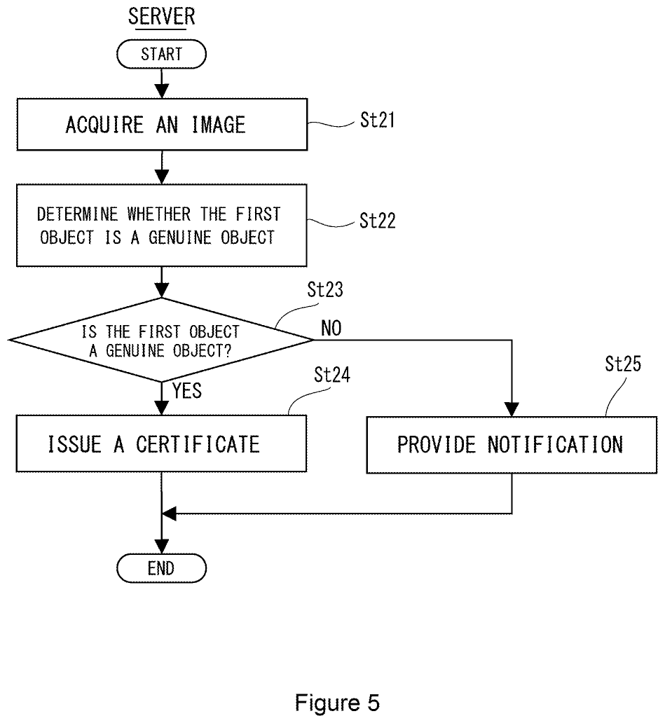

Following is an outline of the program execution process in the second embodiment of the present disclosure. FIG. 5 is a flowchart illustrating an example of the processing of an inspection program according to at least one of the embodiments of the present disclosure.

The image acquisition unit 101 acquires an image (St 21). The determination unit 102 determines whether the first object is a genuine object based on at least a portion of the first object or at least a portion of the second object pertaining to the first object in the image (St 22). When the certificate issuing unit 103 determines that the first object is a genuine object (St 23: YES), it issues an NFT certificate corresponding to the first object (St 24). The notification unit 104 provides notification (St 25) when it is determined that the first object is not a genuine object (St 23: NO).

A detailed description of the image, the first object contained in the image, the second object pertaining to the first object, a portion of the object, the genuine article, and the NFT certificate corresponding to the first object are as in the first embodiment and are therefore omitted.

The notification unit 104 may notify the device pertaining to the entity that wishes to confirm whether or not the first object is genuine. The entity that wishes to confirm whether the first object is genuine refers to, for example, the administrator of the inspection system 100 or the server 10B or a user. Equipment pertaining to the subject means equipment accessible by the subject. For example, if the subject is a user, the device pertaining to the subject is the user terminal 20.

An aspect of the second embodiment is to inform administrators, users, etc. that the first object is not a genuine object.

### Third Embodiment

The following is an overview of a third embodiment of the present disclosure.

The following is an example of a third embodiment with a computer example of an inspection program executed on a server. The server may be the server 10 provided by the inspection system 100 described in FIG. 1.

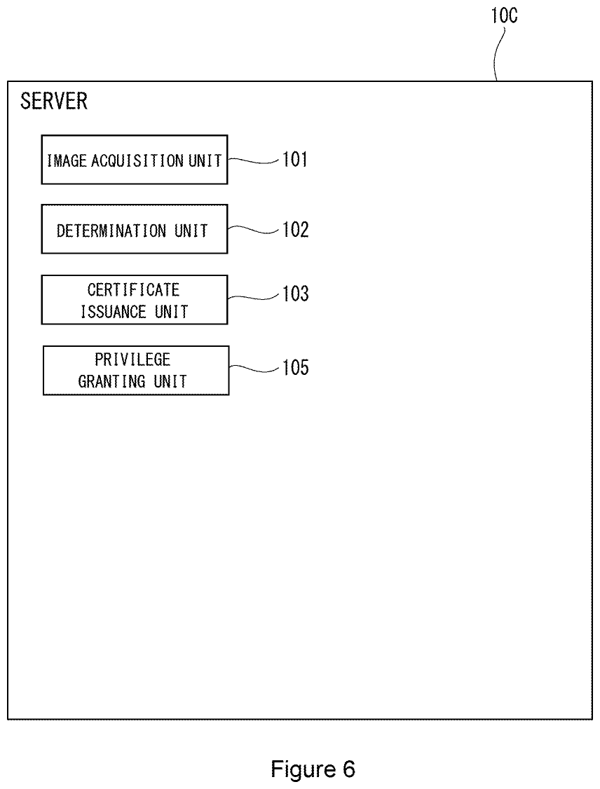

FIG. 6 is a block diagram of the server according to at least one of the embodiments of the present disclosure. The server 10C, an example of the configuration of server 10, has at least an image acquisition unit 101, a determination unit 102, a certificate issuing unit 103 and a privilege granting unit 105. The processor provided by the server 10C functionally realizes the image acquisition unit 101, the determination unit 102, the certificate issuing unit 103 and the privilege granting unit 105 by referring to the inspection program held in the memory device and executing the program.

The image acquisition unit 101 has the function of acquiring images. The determination unit 102 has the function of determining whether or not a first object is a genuine object based on at least a portion of the first object or at least a portion of the second object pertaining to the first object included in the image. The certificate issuing unit 103 has the function of issuing an NFT certificate corresponding to the first object when the first object is determined to be genuine. The privilege granting unit 105 has the function of granting privileges to holders of NFT certificates.

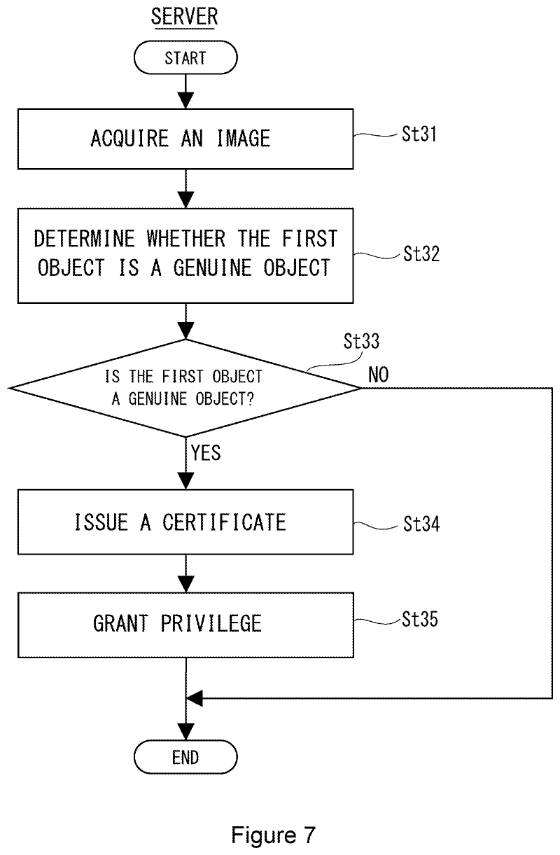

Following is an outline of the program execution process in the third embodiment of the present disclosure. FIG. 7 is a flowchart illustrating an example of the processing of an inspection program according to at least one of the embodiments of the present disclosure.

The image acquisition unit 101 acquires an image (St 31). The determination unit 102 determines whether the first object is a genuine article based on at least a portion of the first object or at least a portion of the second object pertaining to the first object in the image (St 32). When the certificate issuing unit 103 determines that the first object is a genuine article (St 33: YES), it issues an NFT certificate corresponding to the first object (St 34). The privilege granting unit 105 grants privileges to holders of NFT certificates (St 35).

A detailed description of the image, the first object contained in the image, the second object pertaining to the first object, a portion of the object, the genuine article, and the NFT certificate corresponding to the first object are as in the first embodiment and are therefore omitted.

A holder of an NFT certificate refers to a person who is associated with an NFT certificate. This association may be done on the blockchain. That is, the server 10C or other device may determine that the holder of an issued NFT is the holder of an NFT certificate based on transaction information maintained on the blockchain. As long as there is no contradiction, the person who holds the information may be a person in the virtual space. The holder of an NFT certificate is typically a user.

If NFT transfers are not considered, the person holding the NFT certificate may be the person holding the device, such as the user terminal 20, from which the data pertaining to the NFT certificate was obtained.

The privileges may be tangible or intangible. An example of a tangible privilege is a so-called extra product. In this case, the granting of a privilege may be, for example, processing information to send an extra product to the holder of an NFT certificate. For example, information processing, such as the server 10C sending shipping instructions for extra products to the delivery system that manages the delivery of the products, falls under the information processing described above. However, the mode of information processing is not limited to this.

An example of an intangible privilege is game data that can be used in games that can be played by the holder of an NFT certificate. For example, data for weapon items with high attack power and data for characters with high ability values fall under the category of game data described above. The types of game data are not limited to those described above. In this case, the granting of a privilege may be, for example, transmitting the game data described above to the holder of the NFT certificate. Other privileges may be to cause some favorable effect in a game that can be played by the holder of an NFT certificate

An aspect of the third embodiment, since the NFT certificate is proof that the first object was an authentic item, is to grant privileges to the holder of a genuine object based on whether or not they hold an NFT certificate.

### Fourth Embodiment

The following is an overview of a fourth embodiment of the present disclosure. The following is an overview of a fourth embodiment of the present disclosure with an example of an inspection system.

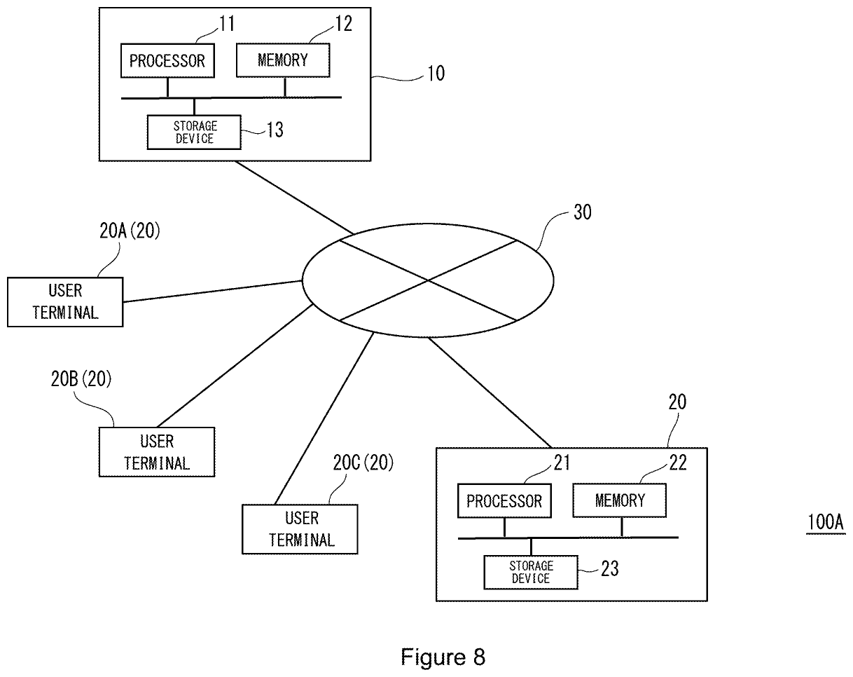

FIG. 8 is a block diagram illustrating an example configuration of an inspection system 100A according to at least one embodiment of the present disclosure. The inspection system 100A, an example of an inspection system, is equipped with a server 10 and a user terminal 20 used by the user. User terminals 20A, 20B, and 20C are examples of user terminals 20, respectively. The configuration of the inspection system 100 is not limited to this. For example, the inspection system 100A may consist of a single-user terminal used by multiple users. The inspection system 100A may have multiple servers.

Server 10 and user terminal 20 are computer examples. Server 10 and user terminal 20 are each communicatively connected to a communication network 30, such as the Internet. The connection between the communication network 30 and the server 10 and between the communication network 30 and the user terminal 20 may be a wired or wireless connection. For example, the user terminal 20 may connect to the communication network 30 by performing data communication with a base station managed by a telecommunications carrier via a wireless communication line.

The inspection system 100A is equipped with a server 10 and a user terminal 20 to realize various functions for executing various processes in response to user operations.

The inspection system 100A may also serve as a game processing system. The games processed by the game processing system may be video games, games that utilize real space, with or without XR technology, etc. If the inspection system 100A serves as a game processing system, the server 10 controls the progression of the game. The server 10 may control the game's progression in response to player operations. The server 10 is managed by the administrator of the inspection system 100A and has various functions for providing information on various processes to multiple user terminals 20. The server 10 may consist of an information processing device, such as a game server, capable of rendering game images. The inspection system and game processing system may be configured by multiple servers.

Server 10 has a processor 11, memory 12, and storage device 13. The processor 11 is a central processing unit such as a central processing unit (CPU) that performs various calculations and controls. If server 10 is equipped with a GPU (Graphics Processing Unit), some of the various calculations and controls may be performed by the GPU. The server 10 executes various types of information processing by the processor 11 using data read out to the memory 12, and stores the resulting processing results in the storage device 13, as necessary.

The storage device 13 functions as a storage medium for storing various types of information. The configuration of the storage device 13 is not particularly limited, but from the viewpoint of reducing the processing load on the user terminal 20, it is preferable to have a configuration that can store all the various information necessary for the control performed by the inspection system 100A. Such examples include HDDs and SSDs. However, the storage device that stores various types of information may be configured to have a dedicated storage area outside of the server 10, for example, as long as the storage area is accessible by the server 10.

The user terminal 20 is connected to the communication network 30 and is equipped with hardware (e.g., a display device that displays a browser screen or game screen according to coordinates) and software to execute various processes by communicating with the server 10. Each of the multiple user terminals 20 may also be configured to communicate directly with each other without the server 10.

The user terminal 20 may consist of a communication terminal that is managed by the user and capable of playing network-distributed games. Examples of communication terminals include, for example, cell phone terminals, PDAs (Personal Digital Assistant), portable gaming devices, VR goggles, AR glasses, smart glasses, AR contacts, and so-called wearable devices. The configuration of user terminals that the inspection system 100 may include is not limited to these. Other examples of user terminal configurations include a combination of various communication terminals, personal computers, and stationary gaming devices.

The user terminal 20 may have a built-in display device. The display device may be connected wirelessly or wired to the user terminal 20. Since the configuration of the display unit is very common, it is not shown here.

When a user terminal is used for gaming purposes, the game screen is displayed by a display device, for example, as a composite image, and the user recognizes this composite image. The game screen is displayed, for example, on a display device provided by the user terminal or a display device connected to the user terminal. Display devices include, for example, hologram display devices that can display holograms, projection devices that project images (including game screens) onto screens, etc., and XR display devices. XR includes Virtual Reality (VR), Augmented Reality (AR), Mixed Reality (MR), and Substitutional Reality (SR).

User terminal 20 has a processor 21, memory 22, and storage device 23. The processor 21 is a central processing unit such as a central processing unit (CPU) that performs various calculations and controls. If the user terminal 20 is equipped with a GPU (Graphics Processing Unit), some of the various calculations and controls may be performed by the GPU. The user terminal 20 executes various types of information processing by the processor 21 using the data read out to the memory 22, and stores the resulting processing results in the memory device 23, as necessary. The storage device 23 functions as a storage medium for storing various types of information.

The user terminal 20 may have a built-in input device. The input device may be connected wirelessly or wired to the user terminal 20. The input device accepts operational input by the user. In response to operation input by the user, the processor provided by the server 10 or the user terminal 20 executes various control processes. Examples of input devices include the touch panel screen provided by mobile terminals, keyboards, mice, gamepads, joysticks, and other controllers. A camera built into or connected to the user terminal 20 can also correspond to an input device. The user performs operation input by gestures such as moving his/her hand in front of the camera (gesture input).

In addition, the user terminal 20 may be equipped with other output devices such as speakers. Other output devices output sound, vibration, and various other information to the user.

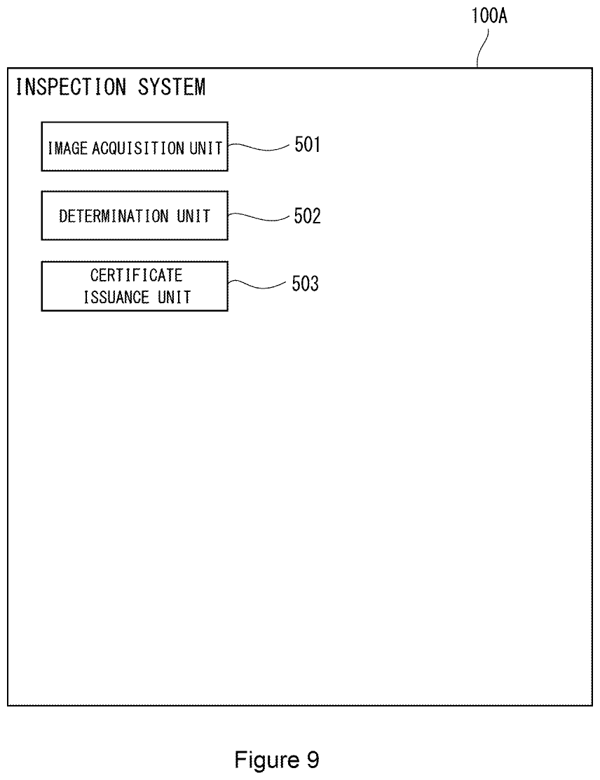

FIG. 9 is a block diagram illustrating the configuration of an inspection system according to at least one of the embodiments of the present disclosure. The inspection system 100A, an example of an inspection system, has at least an image acquisition unit 501, a determination unit 502 and a certificate issuing unit 503. One or more processors provided with the inspection system 100A functionally realize the image acquisition unit 501, the determination unit 502 and the certificate issuance unit 503 by referring to and executing the inspection program held in one or more storage devices provided with the inspection system 100A.

The image acquisition unit 501 has the function of acquiring images. The determination unit 502 has the function of determining whether or not a first object is a genuine object based on at least a portion of the first object or at least a portion of the second object pertaining to the first object included in the image. The certificate issuing unit 503 has the function of issuing an NFT certificate corresponding to the first object when the first object is determined to be genuine.

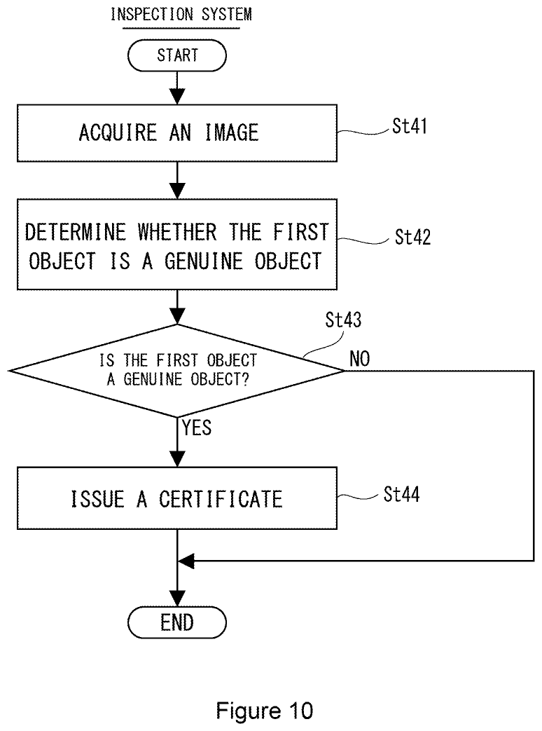

Following is an outline of the program execution process in the forth embodiment of the present disclosure. FIG. 10 is a flowchart illustrating an example of the processing of an inspection program executed by an inspection system according to at least one of the embodiments of the present disclosure.

The image acquisition unit 501 acquires an image (St 41). The determination unit 502 determines whether the first object is a genuine article based on at least a portion of the first object or at least a portion of the second object pertaining to the first object in the image (St 42). When the certificate issuing unit 503 determines that the first object is a genuine article (St 43: YES), it issues an NFT certificate corresponding to the first object (St 44).

The image may be, for example, an image captured by an imaging device provided by the user terminal. The image may be a still or moving image. The inspection system 100A may acquire the captured images directly from the imaging device or via the communication network 30.

The image may be an image captured or generated by a device other than the user terminal. For example, it may be an image captured by an imaging device installed in a store that the user can visit. The stores that the user can visit may be real-world stores or virtual stores located in virtual space. The image may be an image captured or generated in a virtual space.

The first object in the image is the object for which we want to determine whether it is a genuine object or not (authenticity). For example, the first object could be a sold product or other goods.

A second object pertaining to the first object is any other object related to the first object. Related means, for example, that one is attached to the other or that one is packed by the other. To give an example, the second object is a box that packages the figure or a card that comes with the figure. However, the second object is not limited to boxes or cards.

A part of an object may mean, for example, a face, limbs, or other parts if the object is a figure. For example, a part may be only the eye portion of the figure's face. A part can be any part that can be determined to be authentic or fake, and is not limited to the face, limbs, eyes, etc. mentioned above.

The object may be an inanimate object. For example, the object may be a 3D object corresponding to a tangible object such as a figure.

An authentic product means one that is not a fake. For example, goods that have been legitimately sold fall under the category of genuine goods.

An NFT certificate corresponding to the first object means data containing information pertaining to the token associated with the first object. The tokens are NFTs that are registered on the blockchain.

An aspect of the fourth embodiment is that a certificate can be issued after the fact to the person who received the object, indicating that the object is genuine.

### Fifth Embodiment

The following is an overview of a fifth embodiment of the present disclosure. The following is an overview of a fifth embodiment of the present disclosure with an example of an inspection system executed at a user terminal. The user terminal 20X may be any of the multiple user terminals 20, 20A-20C shown in FIG. 1 or FIG. 8.

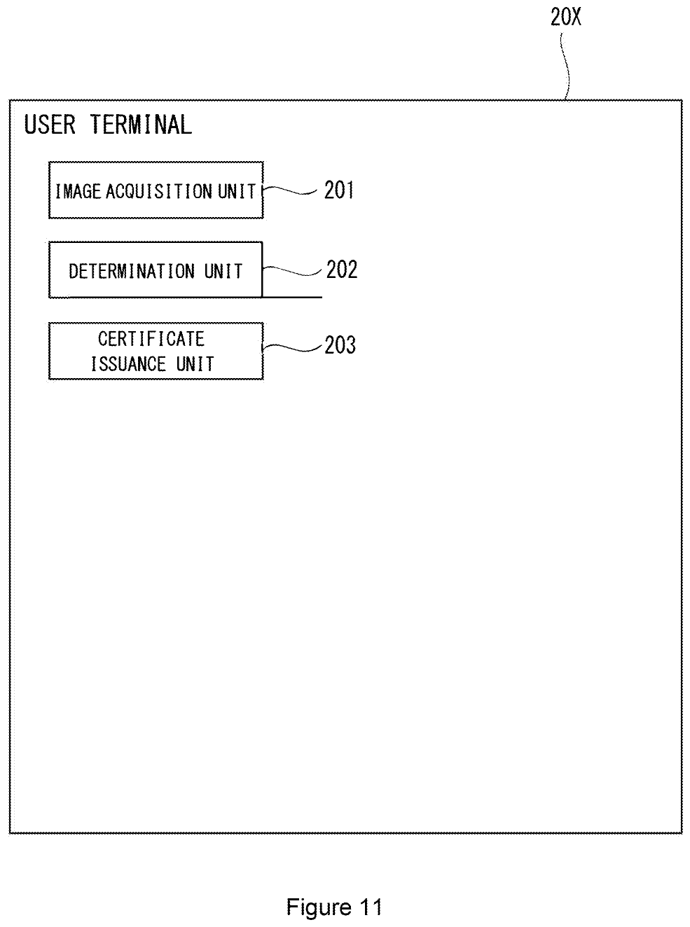

FIG. 11 is a block diagram of a user terminal 20X according to at least one of the embodiments of the present disclosure. The user terminal 20X has at least an image acquisition unit 201, a determination unit 202 and a certificate issuance unit 203. The processor provided by the user terminal 20X refers to the inspection program held in the storage device and executes the program to functionally realize the image acquisition unit 201, the determination unit 202 and the certificate issuance unit 203.

The mage acquisition unit 201 has the function of acquiring images. The determination unit 202 has the function of determining whether or not a first object is a genuine object based on at least a portion of the first object or at least a portion of the second object pertaining to the first object included in the image. The certificate issuing unit 203 has the function of issuing an NFT certificate corresponding to the first object when the first object is determined to be genuine.

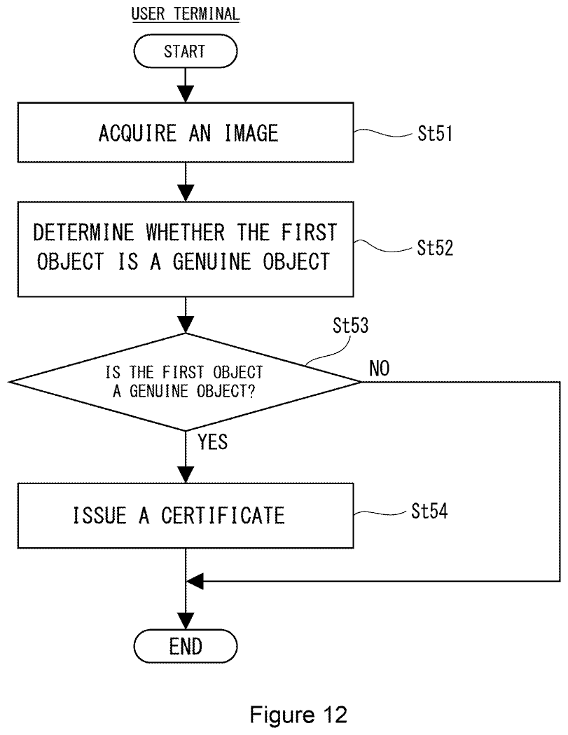

Following is an outline of the program execution process in the fifth embodiment of the present disclosure. FIG. 12 is a flowchart illustrating an example of the processing of an inspection program according to at least one of the embodiments of the present disclosure.

The image acquisition unit 201 acquires an image (St 51). The determination unit 202 determines whether the first object is a genuine article based on at least a portion of the first object or at least a portion of the second object pertaining to the first object in the image (St 52). If the certificate issuing unit 203 determines that the first object is a genuine article (St 53: YES), it issues an NFT certificate corresponding to the first object (St 54).

The image may be, for example, an image captured by an imaging device provided by the user terminal 20X. The image may be a still or moving image.

The image may be an image captured or generated by a device other than the user terminal 20X. For example, it may be an image captured by an imaging device installed in a store that the user can visit. The stores that the user can visit may be real-world stores or virtual stores located in virtual space. The image may be an image captured or generated in a virtual space.

The first object in the image is the object for which we want to determine whether it is a genuine object or not (authenticity). For example, the first object could be a sold product or other goods.

A second object pertaining to the first object is any other object related to the first object. Related means, for example, that one is attached to the other or that one is packed by the other. To give an example, the second object is a box that packages the figure or a card that comes with the figure. However, the second object is not limited to boxes or cards.

A part of an object may mean, for example, a face, limbs, or other parts if the object is a figure. For example, a part may be only the eye portion of the figure's face. A part can be any part that can be determined to be authentic or fake, and is not limited to the face, limbs, eyes, etc. mentioned above.

The object may be an inanimate object. For example, the object may be a 3D object corresponding to a tangible object such as a figure.

An authentic product means one that is not a fake. For example, goods that have been legitimately sold fall under the category of genuine goods.

An NFT certificate corresponding to the first object means data containing information pertaining to the token associated with the first object. The tokens are NFTs that are registered on the blockchain. Issuing an NFT certificate may mean requesting a device other than the user terminal, e.g., the server 10, to issue an NFT certificate.

An aspect of fifth embodiment is that a certificate can be issued after the fact to the person who received the object, indicating that the object is genuine.

### Sixth Embodiment

The following is an overview of a sixth embodiment of the present disclosure. The following is an overview of a sixth embodiment of the present disclosure with an example of an inspection program executed on a server. The server may be the server 10 described in FIG. 1 or FIG. 8.

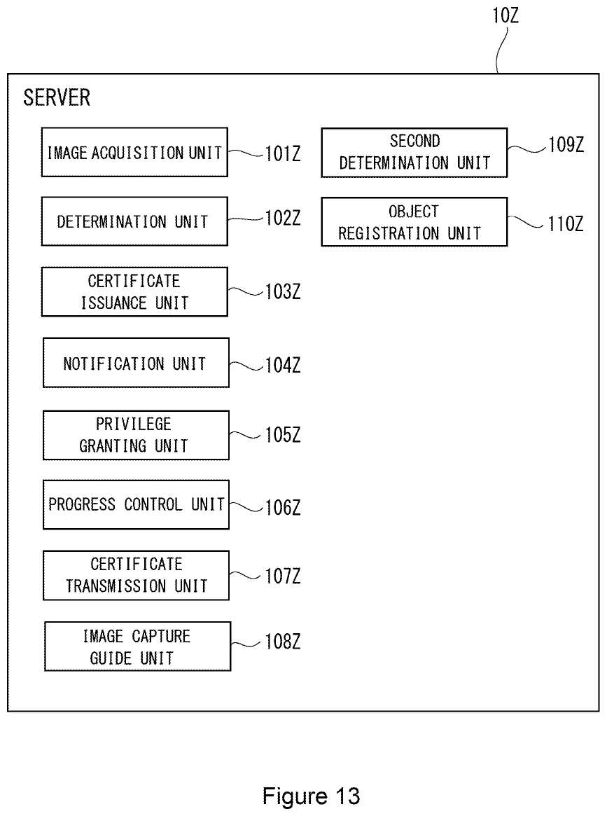

FIG. 13 is a block diagram of a server according to at least one of the embodiments of the present disclosure. The server 10Z, an example of the configuration of server 10, is equipped with at least an image acquisition unit 101Z, a determination unit 102Z, a certificate issuance unit 103Z, a notification unit 104Z, a privilege granting unit 105Z, a progress control unit 106Z, a certificate transmission unit 107Z, an image capture guide unit 108Z, a second determination unit 109Z and an object registration unit 110Z. The processor provided by the server 10Z refers to the inspection program held in the storage device and executes the program to functionally realize the image acquisition unit 101 Z, the determination unit 102Z, the certificate issuing unit 103Z, the notification unit 104Z, the privilege granting unit 105Z, the progress control unit 106Z, the certificate transmission unit 107Z, the image capture guide unit 108Z, the second determination unit 109Z and the object registration unit 110Z.

The image acquisition unit 101Z has the function of acquiring images. The determination unit 102Z has the function of determining whether or not a first object is a genuine object based on at least a portion of the first object or at least a portion of the second object pertaining to the first object included in the image. The certificate issuing unit 103Z has the function of issuing an NFT certificate corresponding to the first object when the first object is determined to be genuine.

The notification unit 104Z has the function of notifying when the first object is determined as not being genuine. The privilege granting unit 105Z has the function of granting privileges to holders of NFT certificates. The progress control unit 106Z has the function of controlling the game's progression. The certificate transmission unit 107Z has the function of transmitting the issued NFT certificate when the first object is determined to be genuine.

The image capture unit 108Z has the function of outputting image guide information indicating at least one of the posture and angle of the target image.

The second determination unit 109Z has the function of determining whether or not the issued NFT certificate satisfies the predetermined conditions. The object registration unit 110Z has the function of registering information pertaining to the first object when the first object is determined to be genuine and the NFT certificate corresponding to the first object is determined to meet the specified conditions.

The privilege granting unit 105Z may further have the ability to generate buff effects in games associated with a person holding an NFT certificate.

The certificate issuing unit 103Z may further be capable of issuing an NFT certificate corresponding to the first object, associated with user-recognizable content.

The certificate issuing unit 103Z may further be capable of issuing a plurality of NFT certificates corresponding to a plurality of first objects such that the plurality of recognizable content corresponding to the plurality of NFT certificates when combined results in said user-viewable content.

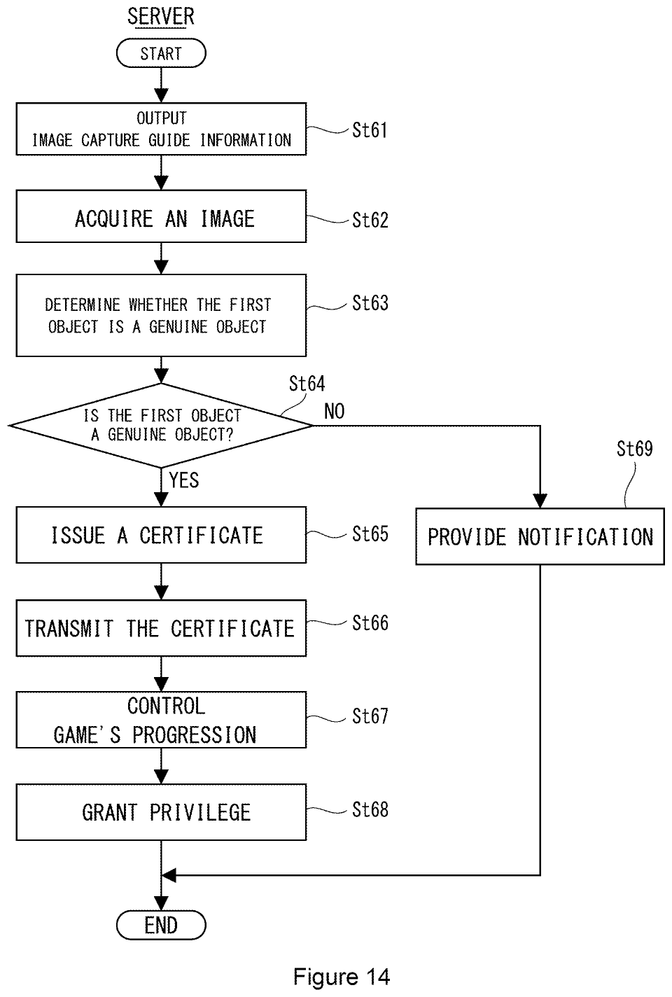

Following is an outline of the program execution process in the sixth embodiment of the present disclosure. FIG. 14 is a flowchart illustrating an example of the processing of an inspection program according to at least one of the embodiments of the present disclosure. In said processing example, the user uses the image capture device of the user terminal 20 to capture an image of the first or second object.

The image capture guide unit 108Z outputs image guide information indicating at least one of the posture and angle of the target image (St 61). The user captures an image the first or second object according to the image capture guide information. The user may capture an image of the first or second object without using the image capture guide information.

The image acquisition unit 101Z acquires images (St 62). This image is the image taken by the user in the processing example.

The determination unit 102Z determines whether the first object is a genuine object based on at least a portion of the first object or at least a portion of the second object pertaining to the first object in the image (St 63). If the first object is determined to be a genuine article (St 64: YES), the certificate issuing unit 103Z issues an NFT certificate corresponding to the first object (St 65). The notification unit 104Z provides notification (St 69) when it is determined that the first object is not genuine (St 64: NO).

If the certificate transmission unit 107Z determines that the first object is a genuine object (St 64: YES), it transmits the issued NFT certificate (St 66).

The progress control unit 106Z controls the game's progression (St 67). The privilege granting unit 105Z grants privileges to holders of NFT certificates (St 68).

The image capture guide information in step St 61 is information indicating at least one of the posture and angle of the target image. The target image refers to the first or second object. The image capture guide information is information indicating the angle and posture of the target image that is suitable for determining the authenticity of the first object. The image capture guide information may be information according to the determination algorithm used for image-based authenticity determination. The image capture guide information may be text information, for example, “Please face the object in front of the camera” or “Please capture the face part of the object”. The image capture guide information may be image information such as a frame line indicating the angle or orientation of the object or a model of the object. Models here include 2D models as well as 3D models. The image capture guide information may be other forms of information, such as audio information.

The person checking whether the first object is a genuine object or not shall capture the image of the first or second object according to the image capture guide information. The person checking whether the first object is a genuine object or not is, for example, a user with a user terminal, but could be someone other than the user. The person checking whether the first object is a genuine object or not may be, for example, an administrator of the inspection system 100 or the server 10Z. For the sake of explanation, we will assume that the person checking whether the first object is a genuine object or not is the user.

The image acquired by the image acquisition unit 101Z in step St 62 may be, for example, an image captured by an imaging device provided by the user terminal.

The image acquired by the image acquisition unit 101Z may be a still or moving image. The server 10Z may acquire the captured images directly from the imaging device or via the communication network 30.

The image acquired by the image acquisition unit 101Z may be an image captured or generated by a device other than the user terminal. For example, it may be an image captured by an imaging device installed in a store that the user can visit. The stores that the user can visit may be real-world stores or virtual stores located in virtual space. The image may be an image captured or generated in a virtual space.

The first object in the image is the object for which we want to determine whether it is a genuine object or not (authenticity). For example, the first object could be a sold product or other goods.

A second object pertaining to the first object is any other object related to the first object. Related means, for example, that one is attached to the other or that one is packed by the other. To give an example, the second object is a box that packages the figure or a card that comes with the figure. However, the second object is not limited to boxes or cards.

A part of an object may mean, for example, a face, limbs, or other parts if the object is a figure. For example, a part may be only the eye portion of the figure's face. A part can be any part that can be determined to be authentic or fake, and is not limited to the face, limbs, eyes, etc. mentioned above.

The object may be an inanimate object. For example, the object may be a 3D object corresponding to a tangible object such as a figure.

An authentic product means one that is not a fake. For example, goods that have been legitimately sold fall under the category of genuine goods.

The NFT certificate corresponding to the first object in step St 65 means data containing information pertaining to the token associated with the first object. The tokens are NFTs that are registered on the blockchain.

In step St 69, the notification unit 104Z may notify the device pertaining to the person checking whether the first object is a genuine object. A device pertaining to a person checking whether or not the first object is a genuine object means a device accessible by that person, for example, a user terminal if that person is a user.

In step St 66, the certificate transmission unit 107Z may transmit the NFT certificate to the device pertaining to the person checking whether or not the first object is a genuine object.

The game in step St 67 is typically a video game, but may be any other game. For example, it can be a so-called city-walking game, etc., in which the user holds a user terminal such as a smartphone and moves around the real world. The controlling entity of the game may be the server 10Z, but a game server separate from the server 10Z may be installed, and the server 10Z and the game server may be communicatively connected via the communication network 30 or the like. In this case, the progress control unit 106Z may delegate control of the game's progression to another game server mentioned above.

The person holding the NFT certificate in step St 68 is the person associated with the NFT certificate. This association may be done on the blockchain. That is, the server 10Z or other device may determine the holder of an issued NFT to be the holder of an NFT certificate based on transaction information maintained on the blockchain. As long as there is no contradiction, the person who holds the information may be a person in the virtual space. The holder of an NFT certificate is typically a user.

If NFT transfers are not considered, the person holding the NFT certificate may be the person holding the device, such as the user terminal 20, from which the data pertaining to the NFT certificate was obtained.

The privileges in step St 68 may be tangible or intangible. An example of a tangible privilege is a so-called extra product. In this case, the granting of a privilege may be, for example, processing information to send an extra product to the holder of an NFT certificate. For example, information processing, such as the server 10Z sending shipping instructions for extra products to the delivery system that manages the delivery of the products, corresponds to the information processing described above. However, the mode of information processing is not limited to this.

An example of an intangible privilege is game data that can be used in games that can be played by the holder of an NFT certificate. For example, data for weapon items with high attack power and data for characters with high ability values fall under the category of game data described above. The types of game data are not limited to those described above. In this case, the granting of a privilege may be, for example, transmitting the game data described above to the holder of the NFT certificate. Other privileges may be to cause some favorable effect in a game that can be played by the holder of an NFT certificate

As an example of an intangible privilege, the privilege granting unit 105Z may generate a buff effect in a game associated with a person holding an NFT certificate. The privilege granting unit 105Z may generate a buff effect on game objects in a game related to a person holding an NFT certificate. Game objects may be, but are not limited to, for example, player characters (PCs), items, magic, or cards that activate skills. The game object may be an object related to the first object. For example, if the first object is a figure, the game object may be a player character corresponding to the figure or a weapon to equip the player character. The target for generating buff effects is not limited to game objects; buff effects may be generated for various elements in the game.

The privilege granting unit 105Z may grant a privilege to the person holding the NFT certificate based on predetermined conditions. A predetermined condition may be, for example, that the NFT certificate has been held for a certain period of time. The predetermined condition may be that a plurality of NFT certificates corresponding to a plurality of first objects are held. Other predetermined conditions than these may be imposed as conditions for granting the privilege.

The content of the privilege may be based on the predetermined conditions mentioned above. For example, if the NFT certificate has been held for one year, a buff effect may be generated that increases the attack power of the game object, the sword, by 1.5 times, and if the NFT certificate has been held for two years, a buff effect may be generated that increases the attack power of the game object, the sword, by 1.8 times.

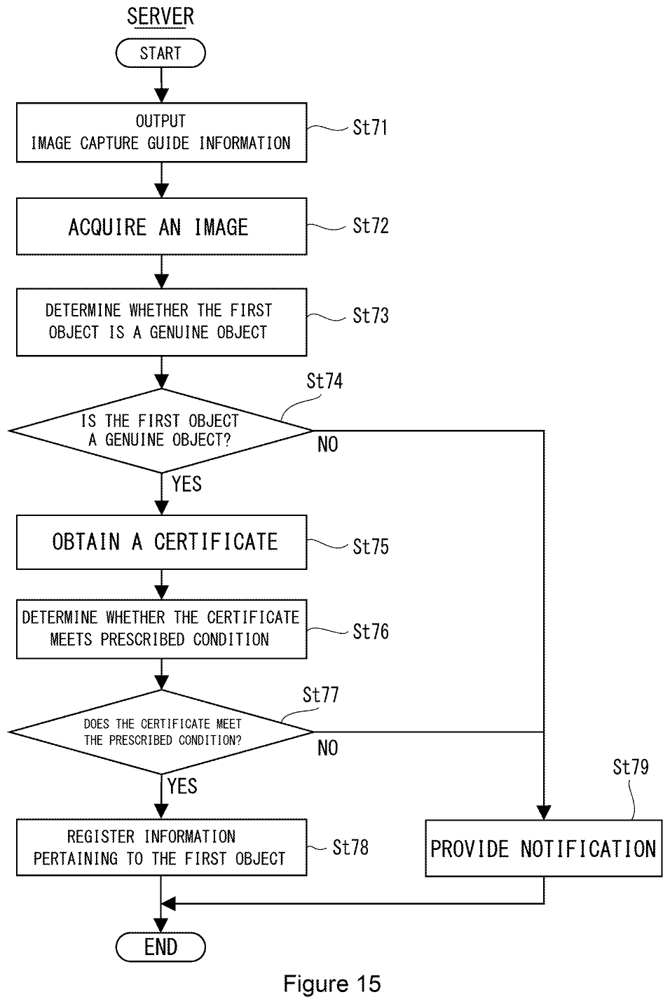

FIG. 15 is a second flowchart illustrating an example of the processing of an inspection program according to at least one of the embodiments of the present disclosure. In said processing example, the user uses the image capture device of the user terminal 20 to capture an image of the first or second object.

The process shown in the flowchart in FIG. 15 is performed, for example, when a user who has already received data pertaining to an NFT certificate transfers or lends the object to be certified by the NFT certificate to another party.

The image capture guide unit 108Z outputs image capture guide information indicating at least one out of the posture and angle of the target image (St 71). The user captures an image the first or second object according to the image capture guide information. The user may capture an image of the first or second object without using the image capture guide information.

The image acquisition unit 101Z acquires images (St 72). This image is the image taken by the user in the processing example.

The determination unit 102Z determines whether the first object is a genuine object based on at least a portion of the first object or at least a portion of the second object pertaining to the first object in the image (St 73). If the first object is determined to be a genuine object (St 74: YES), the second determination unit 109Z obtains the issued NFT certificate (St 75) and determines whether or not said NFT certificate meets the prescribed conditions (St 76). If the first object is determined to be a genuine object (St 74: YES) and the NFT certificate corresponding to the first object is determined to meet the prescribed conditions (St 77: YES), the object registration unit 110Z registers information pertaining to the first object (St 78).

The notification unit 104Z provides notification (St 79) when it is determined that the first object is not genuine (St 74: NO) or when it is determined that the NFT certificate corresponding to the first object does not meet the prescribed conditions (St 77: NO).

Since each process in steps St 71 to St 73 is the same as in steps St 61 to St 63, a detailed explanation is omitted.

The NFT certificate in step St 75 may have been issued in step St 65 or transmitted in step St 66.

The predetermined conditions to be satisfied by the NFT certificate in steps St 76 and St 77 may be set by a person skilled in the art as long as the conditions are such that it can be determined whether the certificate is a legitimate certificate or not.

In step St 78, the object registration unit 110Z registers information pertaining to the first object, allowing the user to process (e.g., register an offer to sell or lend) the first object to transfer or lend it to another person via an object transaction platform or the like. The above process may be for an action other than the transfer or lending of the first object. After the object registration unit 110Z has registered information pertaining to the first object, the object registration unit 110Z may issue an NFT for that object.

In step St 79, the notification unit 104Z may notify the device pertaining to the person holding the first object The person in possession of the first object is, for example, a user. A device pertaining to the person who possesses the first object means a device accessible by the person, for example, a user terminal in the case where the person is a user.

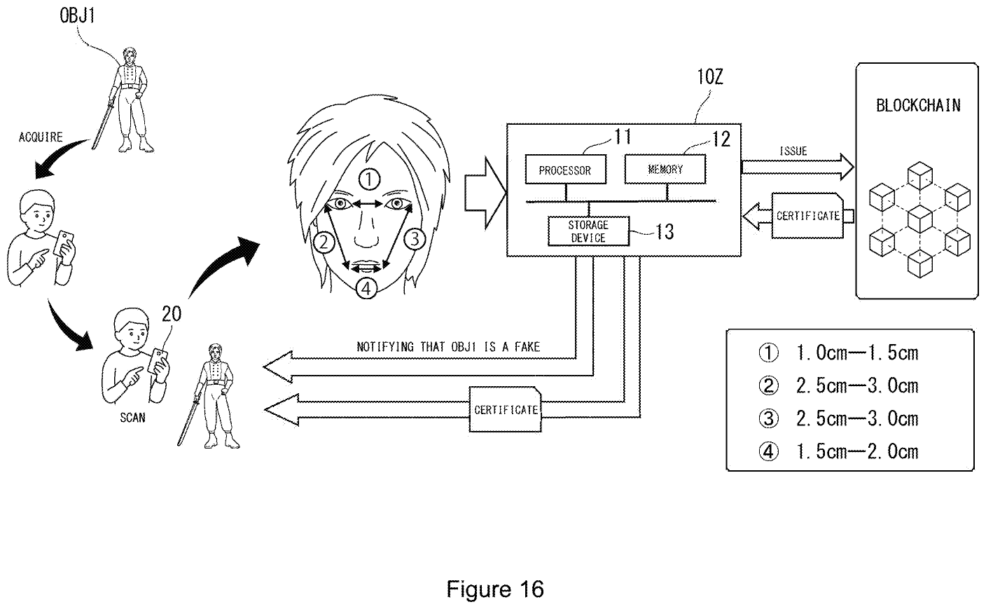

FIG. 16 is a conceptual diagram illustrating inspection processing of a first object according to at least one embodiment of the present disclosure. The conceptual diagram in FIG. 16 corresponds to the flowchart shown in FIG. 14 when the person checking whether the first object is a genuine object is the user.

The user acquires the first object OBJ1 by purchase or other means. The user takes an image of the first object OBJ1 using an imaging device such as a camera provided by the user terminal 20. The first object OBJ1 in this example is a figure. Instead of the first object OBJ1, the user may capture an image of a second object (not shown), such as a box packing the first object OBJ1. For the sake of explanation, we will assume that the user has captured an image of the first object OBJ1.

The direction of the image of the first object OBJ1 and the posture of the first object OBJ1 in the image may not be in a single orientation. For example, multiple images may be acquired by changing the posture of the figure and capturing multiple images, capturing images from different angles, etc. The captured image may be a moving image. The user may capture an image of the first object OBJ1 based on the image capture guide information (step St 61) output from the user terminal 20 via the server 10Z.

The image acquisition unit 101Z of the server 10Z acquires the captured image (step St 62). The determination unit 102Z determines whether the first object OBJ1 is a genuine object based on at least one portion of the first object OBJ1 included in the captured image, the face of the figure (St 63).

The determination algorithm used by the determination 102Z is, for example, based on the distance to the feature. In the illustrated example, if the distance to be characterized is within a predetermined range for the figure's face, the determination unit 102Z determines that the first object OBJ1 is genuine. The following four distances are shown in FIG. 16 for the distances to be characterized.
Distance between the eyes is from 1.0 cm to 1.5 cm
Distance from the corner of the right eye to the right edge of the lip is 2.5 cm to 3.0 cm
Distance from the corner of the left eye to the right edge of the lip is 2.5 cm to 3.0 cm
Lip width from 1.5 cm to 2.0 cm

The determination algorithm used by the determination unit 102Z is not limited to the above, but may be, for example, an algorithm that extracts feature points from the image to make a determination. The determination may be made using a learning model in which machine learning is performed using images pertaining to genuine goods and images pertaining to counterfeit goods as teacher data. Other determination algorithms than these may be used.

If the certificate issuing unit 103Z determines that the first object OBJ1 is a genuine object (St 64: YES), it issues an NFT certificate corresponding to the first object OBJ1 (St 65). The certificate issuing unit 103Z processes the issuance of tokens to the blockchain. The certificate transmission unit 107Z sends the issued NFT certificate to the user terminal 20 (St 66).

On the other hand, if the notification unit 104Z determines that the first object is not a genuine object (St 64: NO), it notifies the user terminal 20 that the first object OBJ1 is a fake (St 69).

The certificate issuing unit 103Z may issue an NFT certificate corresponding to the first object OBJ1 with the user-recognizable content. User-recognizable content is content that can be recognized by the user through the five senses, such as pictures (still images), moving images and sound data. When the first object OBJ1 is a figure, content representing characters, items, etc. corresponding to the figure is handled by linking it to the NFT certificate. It also provides such content to users. This allows the owner of the authentic item to gain additional gains.

In addition, there may not be only one first object for the user to acquire. For example, if there is a game in which a party is composed of three characters, a user who is a fan may want to have three figures corresponding to the three characters. In such a case, the certificate issuing unit 103Z may issue a plurality of NFT certificates corresponding to a plurality of first objects, such that the plurality of recognizable contents corresponding to the plurality of NFT certificates, when combined, become content that can be viewed by said user. For example, suppose there are three pictures (recognizable content) corresponding to three NFT certificates. Each of the three pictures will correspond to three NFT proofs corresponding to the three character figures mentioned above. The three pictures above are then combined to form a picture of the members of one party. This allows those who collect multiple authentic items to gain additional gains. It is possible to combine multiple contents that are unrecognizable on their own corresponding to multiple NFT certificates to form content that can be viewed by said users.

As an aspect of the sixth embodiment, a certificate can be issued after the fact to the person who received the object, indicating that the object is genuine.

An aspect of the sixth embodiment is to inform administrators, users, etc. that the first object is not a genuine object.

An aspect of the sixth embodiment, since the NFT certificate is proof that the first object is an authentic item, is to grant privileges to the holder of the authentic item based on whether or not they hold an NFT certificate.

An aspect of the sixth embodiment, since the NFT certificate is proof that the first object is an authentic item, is to grant the holder of the authentic item advantage in the game based on whether or not they hold an NFT certificate.

An aspect of the sixth embodiment is to allow the recipient of the object to obtain a certificate indicating that an object is a genuine object.

An aspect of the sixth embodiment is that at least one out of the posture and angle of the target image that is effective for determining authenticity can be presented to the person performing the imaging process.

An aspect of the sixth embodiment is that the owner of the genuine object can gain additional gains.

An aspect of the sixth embodiment is that those who collect multiple authentic items can gain additional gains.

An aspect of the sixth embodiment is that a person who has acquired an object may transfer the object to another person after proving that the object is genuine.

As explained above, each of the above-mentioned embodiments of the present disclosure solves one or more deficiencies. The effects of the respective embodiments are examples of non-limiting effects or effects.

As long as there is no inconsistency, certificates may be issued using various forms of tokens, such as RFT (Re-Fungible Token), for example.

In each of the above-mentioned embodiments, the user terminal 20 and the server 10 execute the various processes described above according to various control programs (e.g., inspection programs) stored in their own memory devices. Other computers, not limited to the user terminal 20 or the server 10, may also execute the various processes described above according to various control programs (e.g., inspection programs) stored in their own memory devices.

The configuration of the inspection systems 100 and 100A is not limited to the configurations described in the embodiment examples above. For example, the server may be configured to execute some or all of the processes described as being executed by the user terminal, or the user terminal may be configured to execute some or all of the processes described as being executed by the server. The user terminal may also be configured to have some or all of the memory (storage device) provided by the server. In other words, the inspection systems 100 and 100A may be configured so that one of the user terminals and the server has some or all of the functions of the other.

The program may also be configured to cause a stand-alone device that does not include a communication network to realize some or all of the functions described in the embodiment examples above.

### NOTE

The above description of embodiments describes the disclosure at least in such a way that a person having standard knowledge in the field of the disclosure would be able to perform it.

[1] An inspection program causes a server to implement an image acquisition function to acquire an image, a determination function to determine whether or not the first object is a genuine article based on at least a portion of the first object included in the image or at least a portion of a second object pertaining to the first object, and a certificate issuing function to issue an NFT certificate corresponding to the first object if the first object is determined to be genuine.

[2] The inspection program described in [1], causes the server to implement a notification function to notify when the first object is determined not to be a genuine object.

[3] The inspection program described in [1] or [2],

causes the server to implement a function of granting privileges to holders of NFT certificates.

[4] The inspection program described in [3], causes the server to implement a function to cause a buff effect in games related to the person holding the NFT certificate in the privilege granting function.

[5] The inspection program described in any one of [1] to [4], causes the server to implement a certificate transmission function, transmitting the issued NFT certificate when the first object is determined to be a genuine object.

[6] The inspection program described in any one of [1] to [5], causes the server to implement an image capture guide function that outputs image capture guide information indicating at least one out of the posture and angle of the target image.

[7] The inspection program as described in any one of [1] to [6], causes the certificate issuing function to issue an NFT certificate corresponding to the first object by associating it with user-recognizable content.

[8] The inspection program described in [7], causes the certificate issuing function to issue a plurality of NFT certificates corresponding to a plurality of said first objects in such a way that the plurality of recognizable contents corresponding to said plurality of NFT certificates, when combined, become contents that can be viewed by a user.

[9] The inspection program described in any of [1] to [8], causes the server to be equipped with a second determination function to determine whether or not the issued NFT certificate satisfies the predetermined conditions, and an object registration function to register information pertaining to the first object if the first object is determined to be a genuine object and the NFT certificate corresponding to the first object is determined to satisfy the predetermined conditions.

[10] A program for causing a user terminal capable of communicating with said server to realize at least one of the functions that the inspection program described in any one of [1] to [9] causes the server to realize.

[11] A server on which the inspection program described in anyone of [1] to [9] is installed.

[12] An inspection system comprising a communication network, a server, and a user terminal, the inspection system comprising:

image acquisition means for acquiring an image;

determination means for determining whether or not the first object is a genuine article based on at least a portion of a first object or at least a portion of a second object pertaining to the first object included in the image;

and means for issuing, wherein if the first object is determined to be a genuine article, an NFT certificate corresponding to the first object.

[13] An inspection program causes a user terminal to implement an image acquisition function for acquiring an image, a determination function to determine whether or not the first object is a genuine article based on at least a portion of the first object included in the image or at least a portion of a second object pertaining to the first object, and a certificate issuing function to issue an NFT certificate corresponding to the first object if the first object is determined to be a genuine object.

[14] The user terminal on which the inspection program according to [13] is installed.

[15] An inspection program causes computer device to implement an image acquisition function to acquire an image, a determination function to determine whether or not the first object is a genuine article based on at least a portion of the first object included in the image or at least a portion of a second object pertaining to the first object, and a certificate issuing function to issue an NFT certificate corresponding to the first object if the first object is determined to be a genuine object.

[16] An inspection method by computer device comprising:

an image acquisition process for acquiring an image,

a determination process for determining whether or not the first object is a genuine article based on at least a portion of a first object included in the image or at least a portion of a second object pertaining to the first object, and

a certificate issuance process for issuing a certificate corresponding to the first object if the first object is determined to be a genuine object.

[17] An inspection method by a system equipped with a communication network, a server, and a user terminal comprising:

an image acquisition process for acquiring an image,

a determination process for determining whether or not the first object is a genuine article based on at least a portion of a first object included in the image or at least a portion of a second object pertaining to the first object, and

a certificate issuance process for issuing a certificate corresponding to the first object if the first object is determined to be a genuine object.

### INDUSTRIAL APPLICABILITY

According to one of the embodiments of the present disclosure, it is useful as an inspection program and inspection system in which in-game objects are represented in a variety of ways when a player plays a game.

What is claimed is:

1. A non-transitory computer-readable medium storing an inspection program for causing a server to perform functions comprising:
acquiring an image;
determining whether the first object is a genuine article based on at least a portion of the first object in the image or at least a portion of a second object related to the first object; and
issuing a Non-Fungible Token (NFT) certificate corresponding to the first object if the first object is determined to be a genuine object.

2. The non-transitory computer-readable medium of claim 1, wherein the functions further comprise:
notifying when the first object is determined not to be a genuine object.

3. The non-transitory computer-readable medium of claim 1, wherein the functions further comprise:
granting privileges to holders of NFT certificates.

4. The non-transitory computer-readable medium of claim 3, wherein the granting privileges comprises generating buff effects on game objects in games related to the person holding the NFT certificate.

5. The non-transitory computer readable medium of claim 1 wherein the issuing the NFT certificate comprises issuing the NFT certificate corresponding to said first object by associating the NFT certificate with user-recognizable content.

6. The non-transitory computer readable medium of claim 1, wherein the functions further comprise:
determining whether the issued NFT certificate meets the predetermined conditions; and
registering information related to the first object if the first object is determined to be a genuine article and if the NFT certificate corresponding to the first object is determined to meet the predetermined conditions.

7. An inspection system comprising:
a communication network;
a server;
a user terminal; and
a processor configured to determine whether the first object is a genuine article based on at least a portion of a first object or at least a portion of a second object pertaining to the first object included in the image, and further configured to issue an NFT certificate corresponding to the first object if the first object is determined to be a genuine article.

8. A non-transitory computer readable medium comprising an inspection program for causing a user terminal to perform functions comprising:
acquiring an image;
determining whether the first object is a genuine object based on at least a portion of the first object in the image or at least a portion of a second object related to the first object; and
issuing an NFT certificate corresponding to the first object if the first object is determined to be a genuine object.

9. A non-transitory computer readable medium containing an inspection program for causing a computer device to perform functions comprising:
acquiring an image;
determining whether the first object is a genuine object based on at least a portion of the first object in the image or at least a portion of a second object related to the first object; and
issuing an NFT certificate corresponding to the first object if the first object is determined to be a genuine object.
